(19) United States
(12) Patent Application Publication
(10) Pub. No.: US 2008/0163005 A1
(43) Pub. Date: Jul. 3, 2008

(54) ERROR INJECTION IN PCI-EXPRESS DEVICES

(76) Inventors: Bradley S. Sonksen, Rancho Santa Margarita, CA (US); Richard S. Moore, Irvine, CA (US); Rajendra R. Gandhi, Laguna Niguel, CA (US); Larry L. Tesdall, Tustin, CA (US)

Correspondence Address: KLEIN, O'NEILL & SINGH, LLP, 43 CORPORATE PARK, SUITE 204, IRVINE, CA, 92606, US

(21) Appl. No.: 11/626,817

(22) Filed: Jan. 24, 2007

Related U.S. Application Data
(60) Provisional application No. 60/882,402, filed on Dec. 28, 2006.

(51) Int. Cl. G06F 11/00

(52) U.S. Cl. 714/41; 714/32

(57) ABSTRACT

Method and system for forcing PCI-Express errors in a downstream path and upstream path is provided. The downstream path method includes enabling an error forcing function; determining if an additional stimulus is used for enabling an error condition; sending the additional stimulus to trigger error detection; and detecting a forced error condition at a qualifying event. The upstream path method includes enabling an error forcing function; determining if an additional stimulus is used for enabling an error condition; sending a stimulus to trigger error detection; inserting a forced error condition at a qualifying event; wherein a downstream PCI-Express device inserts the error condition; and detecting the forced error condition; wherein an upstream PCI-Express device detects the forced error condition.

### CROSS-REFERENCE TO RELATED APPLICATIONS

This patent application claims priority to provisional U.S. patent application, Ser. No. 60882402, filed on Dec. 28^{th}, 2006, entitled, “ERROR INJECTION IN PCI-EXPRESS DEVICES” under 35 USC §119, the disclosure of which is incorporated herein by reference in its entirety.

### FIELD OF THE INVENTION

The present invention relates to PCI-Express devices, and particularly to injecting PCI-Express errors.

### RELATED ART

The PCI-Express standard lists various types of errors in the PCI-Express specification, incorporated herein by reference in its entirety. The errors may occur in a downstream link (or path) (i.e. when data from an upstream PCI-Express device is received by a downstream PCI-Express device) and an upstream link (or path) (i.e. when a downstream PCI-Express device sends data to an upstream device via an upstream link). There is a need for method and system to force the defined errors so that hardware, software and combination thereof, can be tested for PCI-Express devices.

### SUMMARY

In one aspect, a method for forcing PCI-Express errors in a downstream path is provided. The method includes enabling an error forcing function; determining if an additional stimulus is used for enabling an error condition; sending the additional stimulus to trigger error detection; and detecting a forced error condition at a qualifying event.

In another aspect, a method for forcing PCI-Express errors in an upstream path is provided. The method includes enabling an error forcing function; determining if an additional stimulus is used for enabling an error condition; sending a stimulus to trigger error detection; inserting a forced error condition at a qualifying event; wherein a downstream PCI-Express device inserts the error condition; and detecting the forced error condition; wherein an upstream PCI-Express device detects the forced error condition.

In yet another aspect, a system for forcing PCI-Express errors in a downstream path is provided. The system includes an upstream PCI-Express device for enabling an error forcing function; determining if an additional stimulus is used for enabling an error condition; and sending the additional stimulus to trigger error detection; and a downstream PCI-Express device for detecting a forced error condition at a qualifying event.

In another aspect, a system for forcing PCI-Express errors in an upstream path is provided. The system includes an upstream PCI-Express device for enabling an error forcing function; determining if an additional stimulus is used for enabling an error condition; and sending a stimulus to trigger error detection; and a downstream PCI-Express device for inserting a forced error condition at a qualifying event; wherein the upstream PCI-Express device detects the forced error condition.

This brief summary has been provided so that the nature of the invention may be understood quickly. A more complete understanding of the invention can be obtained by reference to the following detailed description of the preferred embodiments thereof concerning the attached drawings.

### BRIEF DESCRIPTION OF THE DRAWINGS

The foregoing features and other features of the present invention will now be described with reference to the drawings of the various aspects of this disclosure. In the drawings, the same components have the same reference numerals. The illustrated embodiments are intended to illustrate, but not to limit the invention. The drawings include the following Figures:

FIG. 1A shows a block diagram of a PCI-Express system;

FIG. 1B shows an example of a PCI-Express topology;

FIG. 1C shows an example of the layered PCI-Express structure used for communication between PCI-Express devices;

FIG. 1D is a top-level block diagram of a storage area network;

FIG. 1E shows a block diagram of a host bus adapter, operating as a PCI-Express device;

FIG. 2 is a process flow diagram for forcing PCI-Express errors in a downstream path, according to one embodiment; and

FIG. 3 shows a process flow diagram for forcing errors in an upstream path, according to one embodiment.

### DETAILED DESCRIPTION

In one aspect, a PCI-Express device and method is provided to force PCI-Express standard errors so that a system developer is able to test hardware and software responses to the forced errors. This enables robust design and reliable operations involving PCI-Express devices.

To facilitate an understanding of the various aspects of this disclosure, the general architecture and operation of a PCI-Express system, SAN and a HBA will be described. The specific architecture and operation of the various aspects will then be described with reference to the general architecture of the host system and HBA.

PCI-Express System Overview:

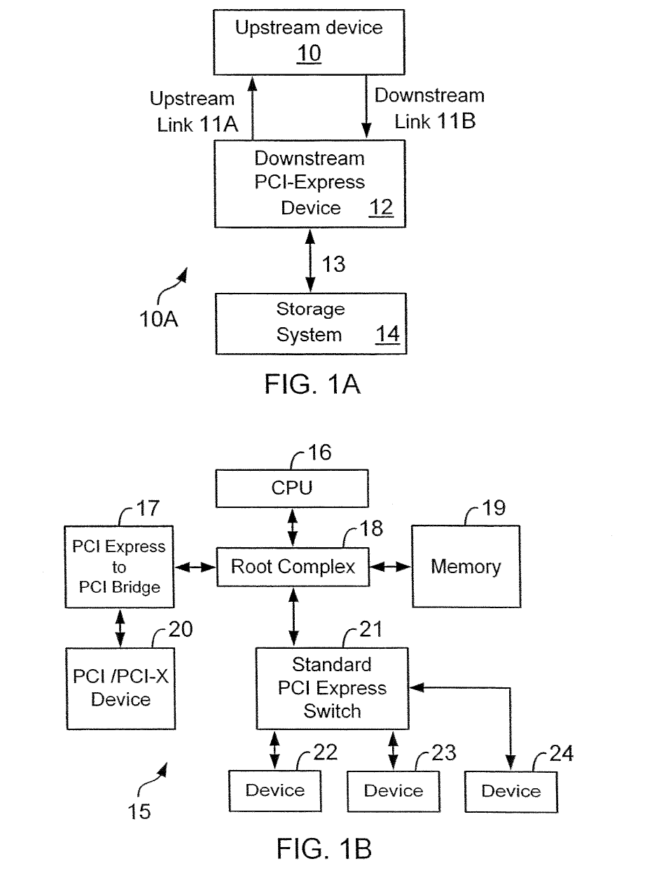

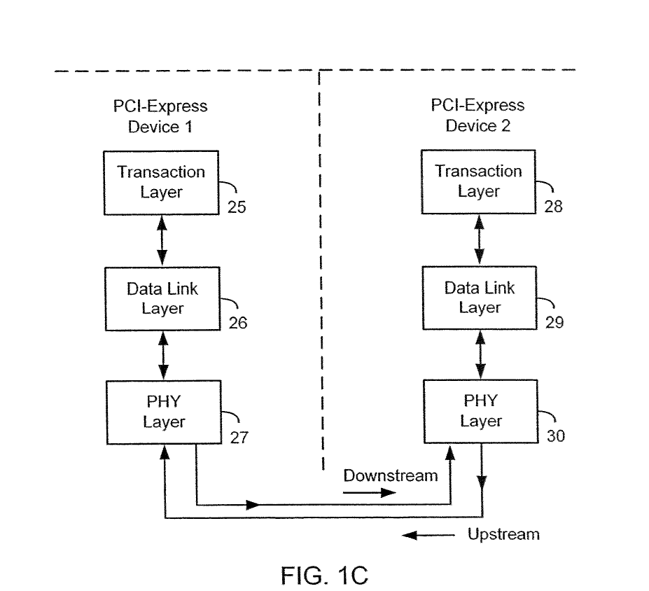

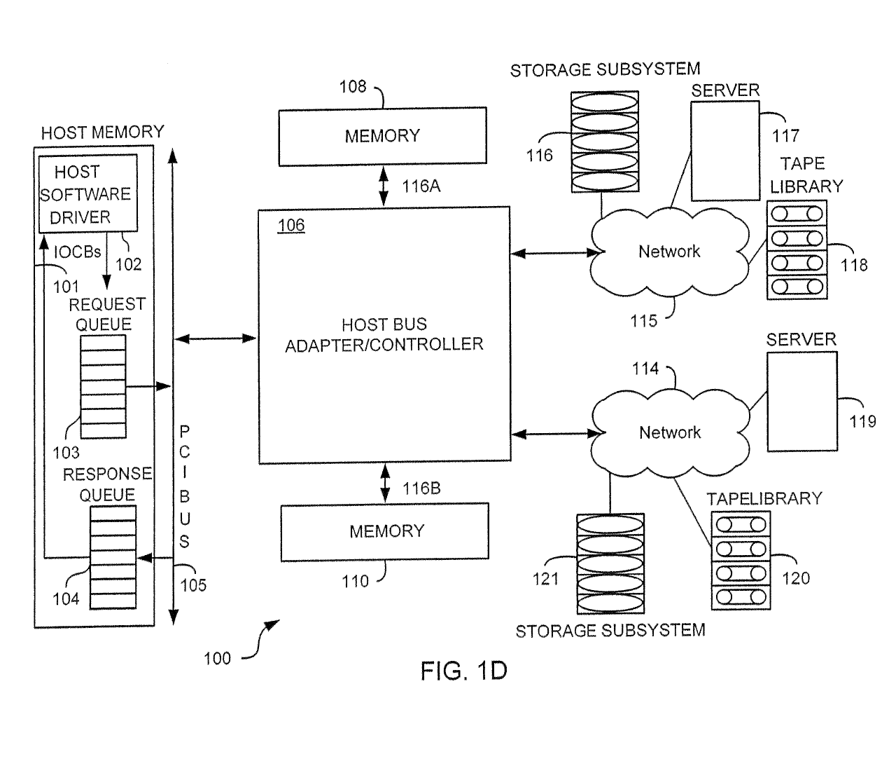

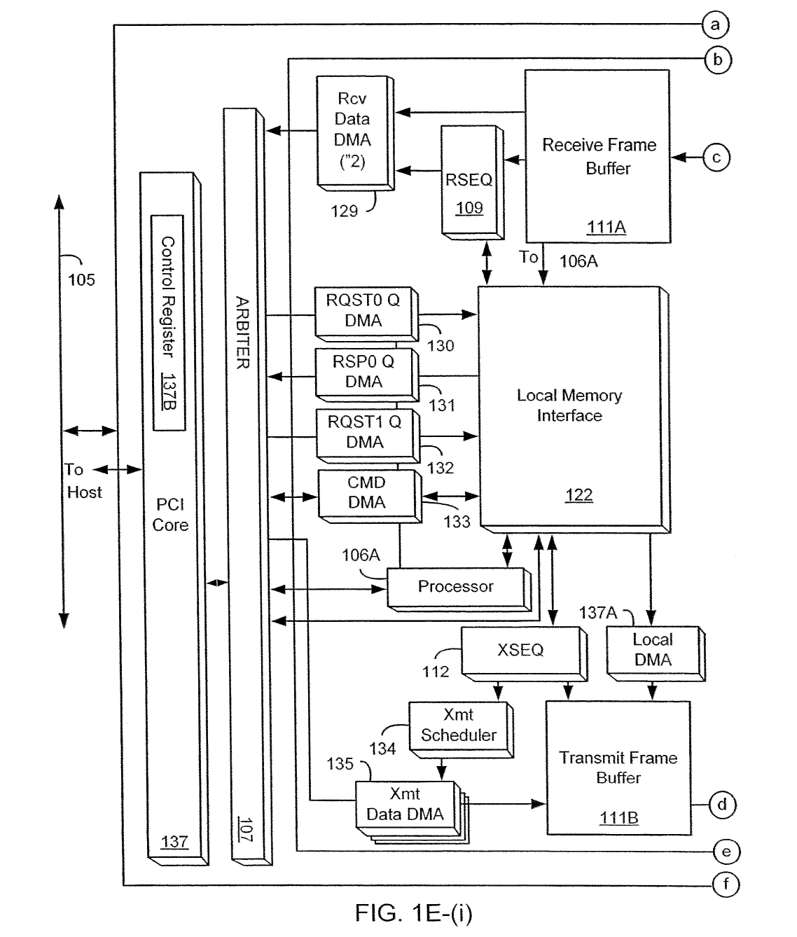

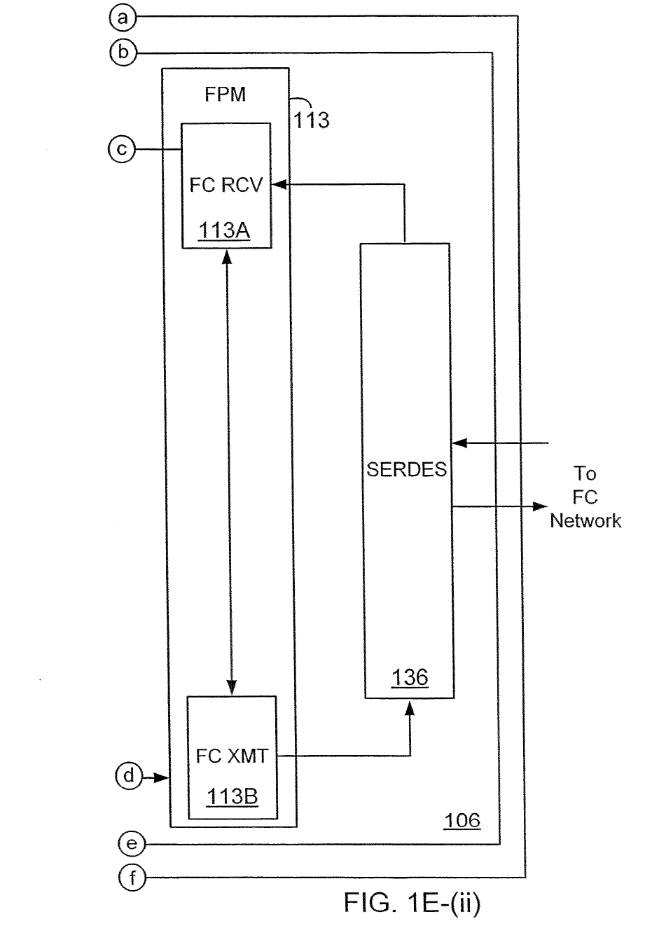

FIG. 1A shows a top-level block diagram of a system 10A that includes an upstream PCI-Express device 10 that communicates with a storage system 14 via a downstream PCI-Express device 12. Upstream PCI-Express link (or path) 11A is used for communication from downstream PCI-Express device 12 to upstream device 10; while downstream link (or path) 11B is used for communication from upstream device 10 to downstream PCI-Express device 12.

Link 13 may be any link, for example, a Fibre Channel link to enable communication between storage system 14 and upstream device 10.

Upstream device 10 may be a computing system (host system) and downstream PCI-Express device 12 may be a host bus adapter (“HBA”, may also be referred to as a “controller” and/or “adapter”), as described below. Although, the examples below are based on host computing systems and HBAs operating in a storage area network (SAN), the various adaptive aspects of the present invention as described in the appended claims are not limited to the SAN environment.

PCI-Express is a standard interface incorporating PCI transaction protocols developed to offer better performance than the PCI or PCI-X bus standards. PCI (Peripheral Component Interconnect), is a local bus standard incorporated herein by reference in its entirety. PCI-X is another standard bus that is compatible with existing PCI cards using the PCI bus. The PCI-X standard is also incorporated herein by reference in its entirety.

PCI-Express is an Input/Output (“I/O”) bus standard (incorporated herein by reference in its entirety) that is compatible with existing PCI cards using the PCI-Express bus.

FIG. 1B shows a block diagram of a PCI Express standard fabric topology 15. A central processing unit (“CPU”) 16 (part of a computing or host system (Upstream device 10, FIG. 1A)) is coupled to a “root complex” 18. Root complex 18 as defined by the PCI Express standard is an entity that includes a Host Bridge and one or more Root Ports. The Host Bridge connects a CPU to a Hierarchy; wherein a Hierarchy is the tree structure based on the PCI Express topology.

Root complex 18 is coupled to a PCI Express/PCI bridge 17 that allows CPU 16 to access a PCI (or PCI-X) device 20. Memory 19 is also coupled to root complex 18 and is accessible to CPU 16.

In addition, Root complex 18 connects to a standard PCI Express switch 21 (may be referred to as “switch”) that is in turn connected to devices 22-24.

CPU 16 can communicate with any of the devices 22-24 via switch 21. It is noteworthy that the path between root complex 18 and any of devices 22-24 may be a direct path with no switch, or it may contain multiple cascaded switches.

PCI Express uses discrete logical layers to process inbound and outbound information. The layers include Transaction Layers 25 and 28, Data Link Layers (“DLL”) 26 and 29 and Physical Layers (“PHY”) 27 and 30, as shown in FIG. 1C. A receive side (downstream) communicates with a transmit side (upstream), and vice-versa.

PCI Express uses a packet-based protocol to exchange information between Transaction layers 25 and 28. Transactions are carried out using Requests and Completions. Completions are used only when required, for example, to return read data or to acknowledge completion of an input/output (I/O) operation.

In the upstream path, packets flow from the Transaction Layer 28 to PHY 30 (via DLL 29) and then processed by PHY layer 27 and sent to Transaction layer 25 for processing via DLL 26.

In the downstream path, packets flow from transaction layer 25 via DLL 26 and PHY layer 27 to PHY layer 30. Thereafter, packets are sent to transaction layer 28 via DLL 29.

Transaction Layer (25 or 28) assembles and disassembles Transaction Layer Packets (“TLPs”). TLPs are used to complete transactions, such as read and write and other type of events.

SAN Overview

Storage area networks (“SANs”) are commonly used where plural memory storage devices are made available to various host computing systems. Data in a SAN is typically moved from plural host systems (that include computer systems) to the storage system through various controllers/adapters. HBAs receive serial data streams (bit stream), align the serial data and then convert it into parallel data for processing. HBAs operate as a transmitting device as well as a receiving device.

Various standard interfaces may be used to move data from host systems to storage devices. Fibre channel is one such standard. Fibre channel (incorporated herein by reference in its entirety) is an American National Standard Institute (ANSI) set of standards, which provides a serial transmission protocol for storage and network protocols such as HIPPI, SCSI, IP, ATM and others Fibre channel provides an input/output interface to meet the requirements of both channel and network users.

FIG. 1D shows a SAN system 100 that uses a HBA 106 (may also be referred to as “adapter 106” or PCI-Express device 106) for communication between a host system (for example, device 10) with host memory 101 with various systems (for example, storage subsystem 116 and 121, tape library 118 and 120, and server 117) using networks 114 and 115. Servers 117 and 119 can also access the storage sub-systems using SAN 115 and 114, respectively

Host systems typically include several functional components. These components may include a central processing unit (CPU) (for example, 16, FIG. 1B), main memory (for example, memory 19, FIG. 1C and host memory 101), input/output (“I/O”) devices, and streaming storage devices (for example, tape drives). In host systems, the main memory is coupled to the CPU via a system bus or a local memory bus. The main memory is used to provide the CPU access to data and/or program information that is stored in main memory at execution time. Typically, the main memory is composed of random access memory (RAM) circuits. A computer system with the CPU and main memory is often referred to as a host system.

The host system uses a driver 102 that co-ordinates data transfers via adapter 106 using input/output control blocks (“IOCBs”). A request queue 103 and response queue 104 is maintained in host memory 101 for transferring information via adapter 106.

HBA 106:

FIG. 1E (i)-(ii) shows a block diagram of adapter 106. Adapter 106 includes processors (may also be referred to as “sequencers”) 112 and 109 for processing data received from storage sub-systems and transmitting data to storage sub-systems. Transmit path in this context means data path from host memory 101 to the storage systems via adapter 106. Receive path means data path from storage subsystem via adapter 106. It is noteworthy, that only one processor is used for receive and transmit paths, and the present invention is not limited to any particular number/type of processors. Buffers 111A and 111B are used to store information in receive and transmit paths, respectively.

Beside dedicated processors on the receive and transmit path, adapter 106 also includes processor 106A, which may be a reduced instruction set computer (“RISC”) for performing various functions in adapter 106.

Adapter 106 also includes fibre channel interface (also referred to as fibre channel protocol manager “FPM”) 113 that includes an FPM 113A and 113B in receive and transmit paths, respectively. FPM (“FC RCV”)113A and FPM (“FC XMT”) 113B allow data to move to/from network devices.

Adapter 106 is also coupled to memory 108 and 110 (referred interchangeably hereinafter) through local memory interface 122 (via connection 116A and 116B, respectively, (FIG. 1A)). Local memory interface 122 is provided for managing local memory 108 and 110. Local DMA module 137A is used for gaining access to move data from local memory (108/110).

Adapter 106 also includes a serial/de-serializer (“SERDES”) 136 for converting serial data to parallel data and vice-versa.

Adapter 106 further includes request queue DMA channel (0) 130, response queue DMA channel 131, request queue (1) DMA channel 132 that interface with request queue 103 and response queue 104; and a command DMA channel 133 for managing command information. Arbiter 107 arbitrates between plural DMA requests for access to PCI-Express bus 105.

Both receive and transmit paths have DMA modules 129 and 135, respectively. Transmit path also has a scheduler 134 that is coupled to processor 112 and schedules transmit operations. Plural DMA channels run simultaneously on the transmit path and are designed to send frame packets.

For a write command, a processor (for example, 16, FIG. 1B) sets up shared data structures in system memory 101. Thereafter, information (data/commands) is moved from host memory 101 to buffer memory 108 in response to the write command.

PCI core 137 includes logic and circuitry to interface adapter 106 with PCI-Express bus 105. PCI core 137 includes a control register 137B that is used to control error injection, according to one embodiment, as described below. Before describing the process flow for injecting errors, the following provides an example of errors that can be injected, according to one embodiment.

The errors are listed in tables 6-2, 6-3, 6-4 in the PCI-Express Base Specification, version V1.1. These errors are generated so that they can be detected in both in the host system and HBA. A bit is set in control register 137B, and the following errors may be triggered.

Downstream Path Errors

Malformed TLP: This asserts an error in a downstream device PCI configuration register (not shown) on a next received MWr (memory write) TLP (“transaction layer packet”) or MRd (memory read) TLP.

Flow Control Protocol Error: This asserts an error in a downstream device PCI configuration register.

Receiver Overflow: This asserts an error in a downstream device PCI configuration register.

Unexpected Completion: This asserts an error in a downstream device PCI configuration register on a next received CplD(completion with data) or Cpl (completion) packet.

Completer Abort: This asserts an error in downstream device PCI configuration registers on a next received MRd TLP. Completer abort status is then sent to an upstream device. Completer is a device, system or component that completes a request.

Completion Timeout: This asserts an error in a downstream device PCI configuration register.

Unsupported Request: This asserts an error in a downstream device PCI configuration register on a next received MWr TLP or MRd TLP. Unsupported request status sent to upstream device.

ECRC (End to end cyclic redundancy code, as defined by the PCI-Express specification) Check Failed: This asserts an error in a downstream device PCI configuration register on a next received MWr TLP or MRd TLP.

Poisoned (defined by the PCI-Express specification) TLP Received: This asserts an error in a downstream device PCI configuration register on a next received MWr TLP or MRd TLP.

Data Link Layer Protocol (DLLP) Error: This asserts an error in a downstream device PCI configuration register.

REPLAY NUM Rollover: This asserts an error in a downstream device PCI configuration register.

Replay Timeout: This asserts an error in a downstream device PCI configuration register.

Bad DLLP: This asserts an error in a downstream device PCI configuration registers.

Bad TLP: This asserts an error in a downstream device PCI configuration register on a next received MWr TLP or MRd TLP.

Receiver Error: This asserts an error in a downstream device PCI configuration registers.

Upstream Path Errors

Malformed TLP: This error causes a TLP to be sent to an upstream device with non-zero traffic class, or other types of malformed TLPs as defined by PCI Express Specification.

Flow Control Protocol Error: This sends a MRd TLP to a downstream device, and the downstream device corrupts Hdr (header) and data fields of a next outbound UpdateFC DLLP is sent to the upstream device. UpdateFC DLLP is defined by the PCI-Express specification and is used for updating credits.

Unexpected Completion: When an MRd TLP is sent to a downstream device that has a corrupted Tag, function number, or other header field of the next outbound packet and then a completion packet is sent to an upstream device.

Completer Abort: When MRd TLP is sent to a downstream device, a completer abort status is flagged in a completion packet sent back to the upstream device.

Completion Timeout: When a MRd TLP is sent to a downstream device, no completion packet is returned to the upstream device.

ECRC Check Failed: When a MRd TLP is sent to a downstream device, it corrupts the ECRC on completion that is sent back to an upstream device.

Poisoned TLP Received: When a MRd TLP is sent to a downstream device, the downstream device sets an EP bit (defined by the PCI-Express specification) of the next completion packet sent to an upstream device.

Data Link Layer Protocol [DLLP] Error: When a MWr TLP is sent to a downstream device, it corrupts the SEQ [sequence] Number of a next outbound ACK packet [acknowledgement packet] sent to the upstream device.

REPLAY NUM Rollover: When a MWr TLP is sent to a downstream device, it NAKs (negative acknowledged packets) a received TLP once, then discards all retries received until a recovery state is reached, causing rollover in an upstream device.

Replay Timeout: When a MWr TLP is sent to a downstream device, it blocks all ACK packets on an incoming received TLP; and looks for matching SEQ # (sequence number) to unblock an ACK response back to an upstream device.

Bad DLLP: When a MRd TLP is sent to a downstream device, the downstream device inverts 16 bit LCRC (link cyclic redundancy code) of a next outbound DLLP (tx update fc) that is sent to an upstream device.

Bad TLP: When a MRd TLP is sent to a downstream device, the downstream device inverts LCRC (or link CRC) of a next outbound completion TLP. After the downstream device receives a NAK packet, the DLL packet is sent with the TLP with correct LCRC on a second try, to an upstream device.

Receiver Error: A downstream device forces disparity errors or an undefined symbol code while sending a Logical Idle primitive to an upstream device.

Process Flow:

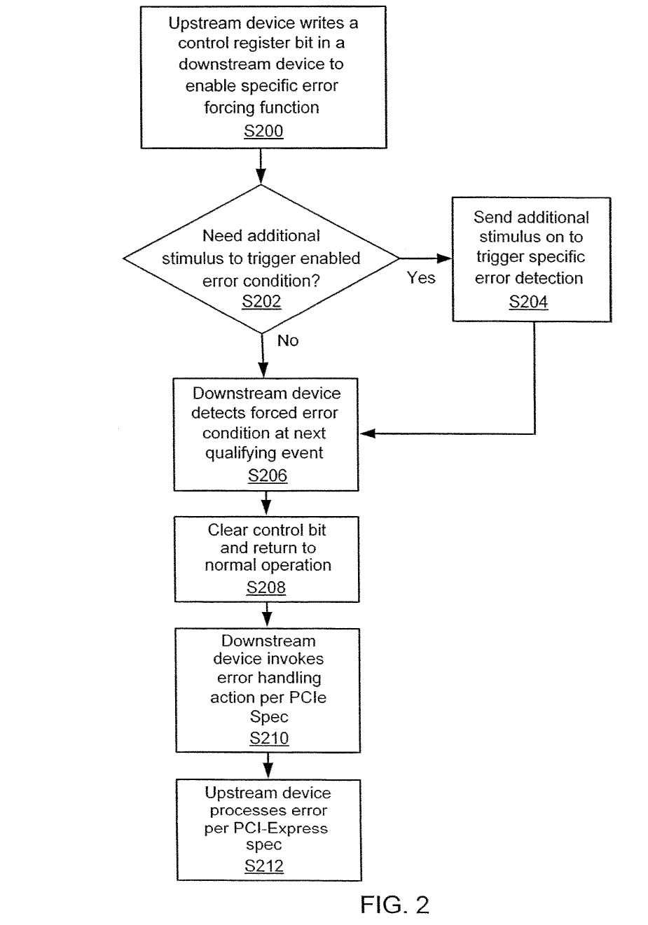

FIG. 2 shows a process flow diagram for forcing errors in a downstream path, according to one aspect. The process starts in step S200, when a host system or other upstream PCI Express device (for example, device 10, FIG. 1A) writes a control bit in register 137A to enable a specific error forcing function within HEA 106, or any other downstream PCI Express device.

In step S202, the host determines if an additional stimulus is needed to trigger an error condition set in step S200. If yes, then in step S204, the host system sends the additional stimulus. The additional stimulus depends on the type of error that is being forced. For certain types of errors, the host system may have to perform certain extra operations to generate the stimulus besides setting the control bit. For example, if TLP errors are being generated (i.e., badTLP), a TLP needs to be sent to the downstream device before the error can be triggered. For other error types (i.e., receiver error), the error can be forced on the downstream device without any action on the part of the upstream device besides setting the error forcing control bit.

If no additional stimulus is needed, then in step S206, HBA 106 detects forced error condition on the PCI-Express link at a qualifying event. The event is based on the error type, for example, receiving a data packet alone may be a qualifying event.

In step S208, HBA 106 clears the control bit that is set in step S200 and operates normally. In step S210, HBA 106 invokes an error handling action. The action would depend on the type of error that was forced. For example, HBA 106 may set applicable PCI-Express error status bits in a register (not shown). HBA 106 then may send a message to the host system to report the detected error.

In step S212 the host system responds to error reported by HBA 106. The host detects any error message sent by HBA 106 and reads the status bits in HBA 106. The host system then performs any operation, for example, link reset and others, to clear the error. The host system may also re-initialize HBA 106 and the appropriate link as part of the error handling action.

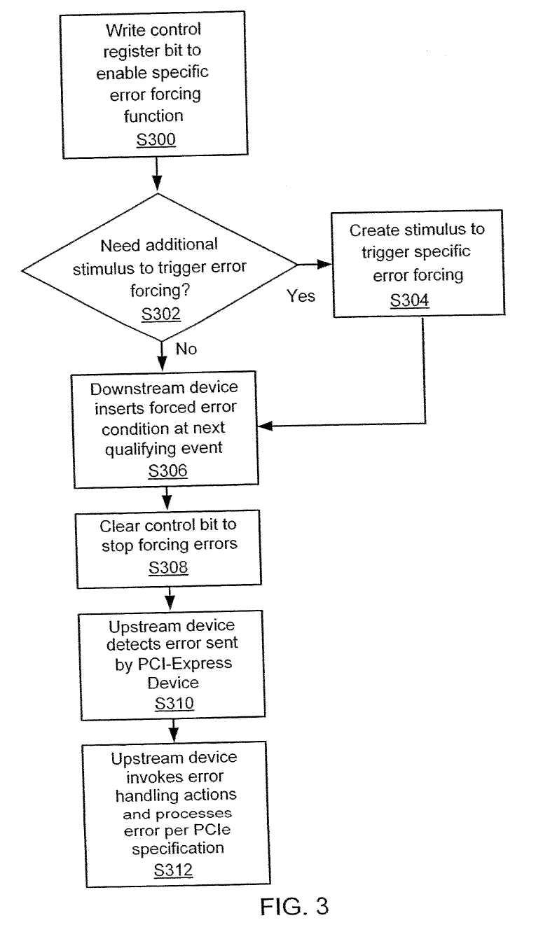

FIG. 3 shows a process flow diagram for forcing errors in an upstream path (for example, from HBA 106 to a host system), according to one aspect. The process starts in step S300, when an upstream device 10 (for example, a host system) writes a control register 137B bit to enable specific error forcing function. In step S302, the host system determines if any additional stimulus is needed to force the specific error on the upstream link (11A, FIG. 1A). If yes, then in step S304, the additional stimulus is created. As explained above, the additional stimulus depends on the type of error that is forced.

If additional stimulus is not needed, then in step S306, HBA 106 forces an error condition at a next qualifying event. Once again, the condition depends on the type of error. For example, if TLP errors are being forced, then HBA 106 waits until a TLP is actually generated before attempting error transmission.

In step S308, HBA 106 clears the control bit to stop forcing errors and performs standard operations. In step S310, the upstream device 10 (or host system) detects the error sent by HBA 106. In step S312, the upstream device invokes error handling actions and processes the forced errors based on the PCI-Express specification.

In one aspect, standard PCI-Express errors are forced, which allows system developers to test hardware and software responses to the forced errors for developing firmware and system diagnostics.

Although the present invention has been described with reference to specific embodiments, these embodiments are illustrative only and not limiting. Many other applications and embodiments of the present invention will be apparent in light of this disclosure and the following claims.

What is claimed is:

1. A method for forcing PCI-Express errors in a downstream path, comprising:
enabling an error forcing function;
determining if an additional stimulus is used for enabling an error condition;
sending the additional stimulus to trigger error detection; and
detecting a forced error condition at a qualifying event.

2. The method of claim 1, wherein a control bit is set to enable the error forcing function.

3. The method of claim 2, wherein an upstream PCI-Express device sets the control bit in a downstream PCI-Express device.

4. The method of claim 1, wherein an upstream device sends the stimulus to a downstream PCI-Express device to trigger error detection and the downstream PCI-Express device detects a forced error condition.

5. The method of claim 4, wherein the downstream PCI-Express device clears a control bit after forced error detection.

6. A method for forcing PCI-Express errors in a upstream path, comprising:
enabling an error forcing function;
determining if an additional stimulus is used for enabling an error condition;
sending a stimulus to trigger error detection;
inserting a forced error condition at a qualifying event; wherein a downstream PCI-Express device inserts the error condition; and
detecting the forced error condition; wherein an upstream PCI-Express device detects the forced error condition.

7. The method of claim 6, wherein a control bit is set by the upstream device to enable the error forcing function.

8. The method of claim 7, wherein the upstream PCI-Express device sets the control bit in the downstream PCI-Express device.

9. The method of claim 7, wherein the downstream PCI-Express device clears the control bit after forced error detection.

10. The method of claim 6, wherein the downstream PCI-Express device inserts error for an upstream link.

11. A system for forcing PCI-Express errors in a downstream path, comprising:
an upstream PCI-Express device for enabling an error forcing function; determining if an additional stimulus is used for enabling an error condition; and sending the additional stimulus to trigger error detection; and
a downstream PCI-Express device for detecting a forced error condition at a qualifying event.

12. The system of claim 11, wherein a control bit is set by the upstream PCI-Express device to enable the error forcing function.

13. The system of claim 12, wherein the upstream PCI-Express device is a host computer and the downstream PCI-Express device is a host bus adapter.

14. The system of claim 11, wherein the upstream PCI-Express device sends the stimulus to the downstream PCI-Express device to trigger error detection and the downstream PCI-Express device detects a forced error condition.

15. The system of claim 14, wherein the downstream PCI-Express device clears a control bit after forced error detection.

16. A system for forcing PCI-Express errors in a upstream path, comprising:
an upstream PCI-Express device for enabling an error forcing function; determining if an additional stimulus is used for enabling an error condition; and sending a stimulus to trigger error detection; and
a downstream PCI-Express device for inserting a forced error condition at a qualifying event; wherein the upstream PCI-Express device detects the forced error condition.

17. The system of claim 16, wherein a control bit in a control register is set by the upstream device to enable the error forcing function.

18. The system of claim 17, wherein the downstream PCI-Express device clears the control bit after forced error detection.

19. The system of claim 16, wherein the upstream PCI-Express device is a host computer and the downstream PCI-Express device is a host bus adapter.
